(19) United States
(12) Patent Application Publication
(10) Pub. No.: US 2013/0292938 A1
(43) Pub. Date: Nov. 7, 2013

(54) External clamshell slip joint seal

(71) Applicants: Tazio S. Grivetti, Chillicothe, IL (US); Robert A. Sarsfield, Dunlap, IL (US)

(72) Inventors: Tazio S. Grivetti, Chillicothe, IL (US); Robert A. Sarsfield, Dunlap, IL (US)

(73) Assignee: CATERPILLAR INC., Peoria, IL (US)

(21) Appl. No.: 13/462,642

(22) Filed: May 2, 2012

(51) Int. Cl. F16L 27/12; F16L 21/00

(52) U.S. Cl. 285/298; 277/314

(57) ABSTRACT

A slip joint seal for a slip joint that includes an outer pipe and an inner pipe. The slip joint seal includes a clamshell clamp with an upper portion and a lower portion mateable to one another to form a hollow cylindrical ring. The ring has a base portion, a protruding portion, an inner surface, and an outer surface. A band fits around the base portion for securing the upper and lower portions to one another around the slip joint. The slip joint seal has a ceramic fiber filament fiber with a first portion that fits within the base portion and surrounds a portion of the slip joint around a slidable interface. A second portion fits within the protruding portion and fills an annular channel of the slip joint. The clamshell clamp and the filament discourage leaking from the interface between the inner pipe while allowing relative movement between the inner pipe and the outer pipe.

### TECHNICAL FIELD

This patent disclosure relates generally to seals and, more particularly, to slip joint seals.

### BACKGROUND

Slip joints are used in many industrial and mechanical applications, particularly in joining pipes. Two pipe segments joined by a slip joint are coupled to one another allowing a fluid connection to be made while allowing axial movement between the pipes. This movement can be caused by various physical forces such as thermal expansion and contraction. Machinery, such as cars, trucks, and other industrial equipment, sometimes utilizes slip joints in exhaust systems due to the thermal expansion and contraction that occurs in those components during operation.

Slip joints have historically encountered leakage of the sealed fluid at the sealed joint. Attempts have been made to stop this leakage using graphite-based seals placed over the joint and held into place by a steel clamp. The graphite seals, however, wear out quickly, resulting in leakage at the slip joint.

### SUMMARY

The disclosure describes, in one aspect, a slip joint seal including a clamshell clamp. The clamshell clamp includes a generally cylindrical upper portion and a generally cylindrical lower portion that mates with the generally cylindrical upper portion to form a hollow cylindrical ring. The hollow cylindrical ring includes a base portion, a protruding portion, an inner surface, and an outer surface. The clamshell clamp also includes a band that fits around the base portion for securing the generally cylindrical upper and lower portions to one another around the slip joint. The slip joint seal also includes a ceramic fiber filament adapted to discourage leaking from an annular channel formed between an inner pipe and an outer pipe while allowing relative movement between the inner pipe and the outer pipe. The ceramic fiber filament includes a first portion that fits substantially within the base portion and is adapted to be disposed in surrounding relation to a portion of the outer pipe around a slidable interface between the inner pipe and the outer pipe. A second portion fits substantially within the protruding portion and is adapted to be disposed within and substantially fill the annular channel.

In another aspect, the disclosure describes an exhaust system with a slip joint and slip joint seal. The slip joint includes an outer pipe including an accepting end, and the accepting end includes an inner bore. An inner pipe that includes a flange protruding radially away from an outer diameter of the inner pipe. The outer diameter includes a clearance fit when disposed within the inner bore of the accepting end of the outer pipe, and a slidable interface is defined between the inner pipe and the outer pipe. An annular channel extends peripherally around a portion of the inner pipe that is defined between a free end of the outer pipe, an outer surface of the inner pipe, and an annular surface of the flange. The annular channel is peripherally open on the side that is radially away from the inner pipe and is in fluid communication with the slidable interface. The exhaust system also includes a slip joint seal that includes a clamshell clamp. The clamshell clamp includes a generally cylindrical upper portion and a generally cylindrical lower portion that is mateable with the generally cylindrical upper portion to form a hollow cylindrical ring. The hollow cylindrical ring includes a base portion, a protruding portion, an inner surface, and an outer surface. A band fits around the base portion for securing the upper and lower portions to one another around the slip joint. The slip joint seal also has a ceramic fiber filament that discourages leaking from the annular channel while allowing relative movement between the inner pipe and the outer pipe. The ceramic fiber filament includes a first portion that fits substantially within the base portion and is adapted to be disposed in surrounding relation to a portion of the outer pipe around the slidable interface. A second portion fits substantially within the protruding portion and is adapted to be disposed within and substantially fill the annular channel.

In another aspect, the disclosure describes a method for sealing a slip joint including sliding an inner pipe that includes an outer diameter and a flange protruding radially away from the outer diameter at least partially into an inner bore of an accepting end of an outer pipe to form the slip joint between the inner and outer pipes. The outer diameter and inner bore are sized to provide a clearance fit therebetween, such that an annular channel that extends peripherally around a portion of the inner pipe is defined between a free end of the outer pipe, an outer surface of the inner pipe, and an annular surface of the flange. The annular channel is peripherally open on the side that is radially away from the inner pipe and is in fluid communication with a slidable interface. The method also includes assembling upper and lower portions of a clamshell clamp to one another to form a hollow cylindrical ring around the slip joint. The hollow cylindrical ring includes a base portion, a protruding portion, an inner surface, and an outer surface. The method also includes fitting a band around the base portion and securing the upper and lower portions to one another around the slip joint The method also includes installing a ceramic fiber filament around the slip joint that discourages leaking from the annular channel while allowing relative movement between the inner pipe and the outer pipe The ceramic fiber filament includes a first portion and a second portion such that the first portion is substantially within the base portion in surrounding relation to a portion of the outer pipe around the slidable interface, and the second portion is substantially disposed within the protruding portion and extends into and substantially fills the annular channel.

### BRIEF DESCRIPTION OF THE DRAWINGS

FIG. 1 is a partial cross-sectional view of a slip joint in accordance with the disclosure.

FIG. 2 is a partial cross-sectional view of a slip joint seal installed on the slip joint of FIG. 1.

FIG. 3 is a perspective view of the slip joint seal of FIG. 2.

FIG. 4 is a perspective view of a clamshell clamp of the slip joint seal of FIG. 2.

FIG. 5 is a front view of the clamshell clamp of FIG. 4.

FIG. 6 is a sectional side view of the clamshell clamp of FIG. 4.

FIG. 7 is a back view of the clamshell clamp of FIG. 4.

FIG. 8 is a partial sectional side view of the clamshell clamp of FIG. 4.

FIG. 9 is a front view of a filament of the slip joint seal of FIG. 2.

FIG. 10 is a side view of the filament of FIG. 10.

FIG. 11 is a sectional side view of the slip joint seal of FIG. 2.

FIG. 12 is a front view of another embodiment of a filament of the slip joint seal of FIG. 2.

FIG. 13 is a side view of the filament of FIG. 12.

### DETAILED DESCRIPTION

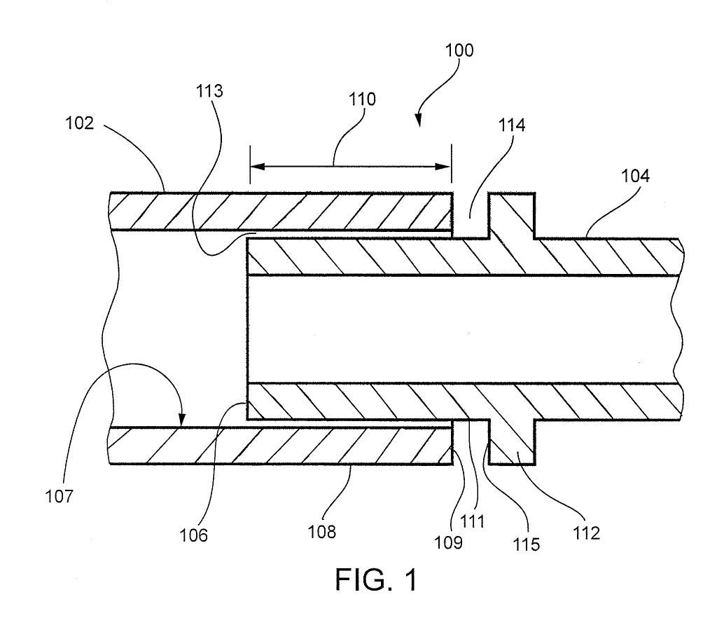

This disclosure relates to a slip joint seal 100. A slip joint is a type of joint that couples two pipe segments in a manner that allows the two pipe segments to move axially with respect to one another. FIG. 1 illustrates an example of a slip joint 100 coupling two pipes, an outer pipe 102 and an inner pipe 104, without a seal. Slip joints such as the type shown in FIG. 1 are found, for example, in exhaust manifolds of on-highway trucks or other industrial machines. An insertion end 106 of the inner pipe 104 fits into an accepting end 108 of the outer pipe 102. The accepting end 108 has an inner bore 107 that has a clearance fit with the outer diameter of the inner pipe 104. The clearance between the insertion end 106 of the inner pipe 104 and the inner bore 107 of the outer pipe 102 at an overlapping area 110 defines a slidable interface 113 between the inner pipe and the outer pipe. The outer pipe 102 can move axially with respect to the inner pipe 104 until the accepting end 108 contacts a flange 112 on the inner pipe. The flange 112 protrudes radially away from the outer diameter of the inner pipe 104. Slip joints 100 such as the one illustrated in FIG. 1 create fluid communication from one pipe segment to another while also allowing axial movement of the pipes in response to various physical forces, such as thermal expansion and contraction.

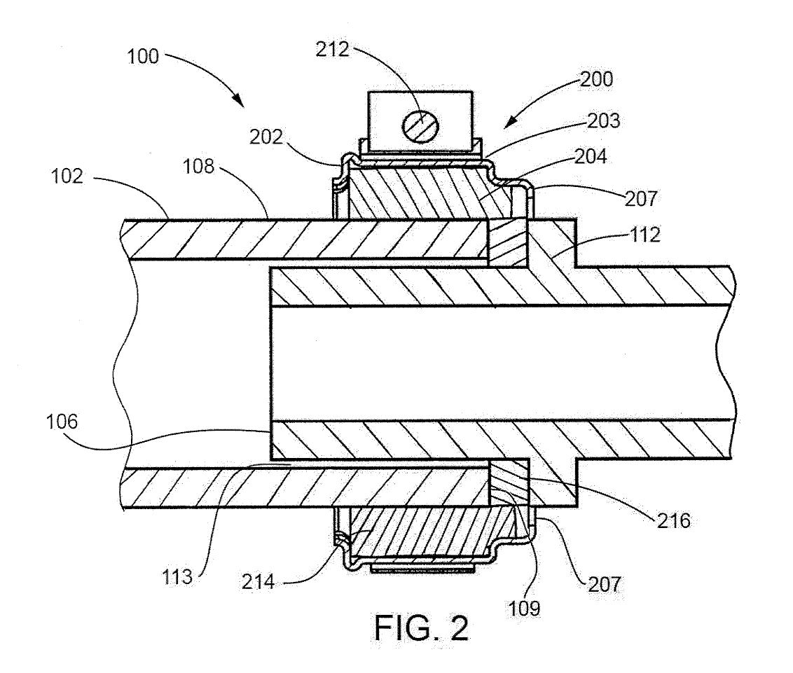

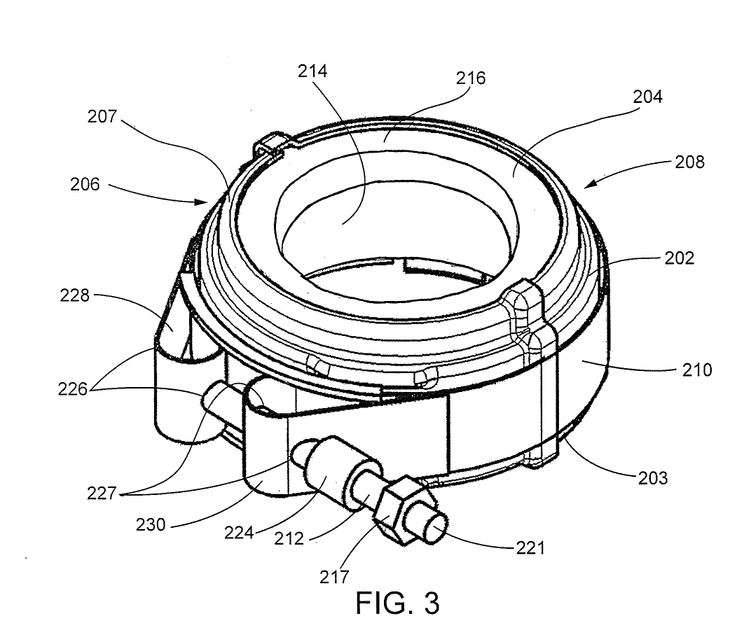

As material passes through a slip joint, exhaust gas and other particles, such as oil and soot, can leak from the slidable interface 113 between the outer pipe 102 and inner pipe 104 through an annular channel 114 that extends peripherally around a portion of the inner pipe 104. The annular channel 114 is defined between a free end 109 of the outer pipe 102, an outer surface 111 of the inner pipe, and an annular surface 115 of the flange 112. The annular channel 114 is peripherally open on one side that is radially away from the inner pipe 104 and in fluid communication with the slidable interface 113. The interface 113 exists where the outer pipe 102 overlaps the inner pipe 104, which allows the two pipes to slide relative to one another while maintaining a fluid path. The width of the annular channel 114 varies as the inner pipe 104 moves with respect to the outer pipe 102. FIG. 2 illustrates a slip joint 100 with a slip joint seal 200 installed to stop the fluid and particles from leaking from the joint without affecting the axial movement capability of the joint. The slip joint seal 200 is illustrated in FIG. 3 and includes a clamshell clamp 202 and a filament 204. As shown in FIG. 2, the clamshell clamp 202 holds the filament 204 in place on the slip joint 100, filling in the annular channel 114. Fluid and particles that escape the joint 100 between the outer pipe 102 and inner pipe 104 are obstructed by the filament 204 and not allowed to leak beyond the slip joint seal 200.

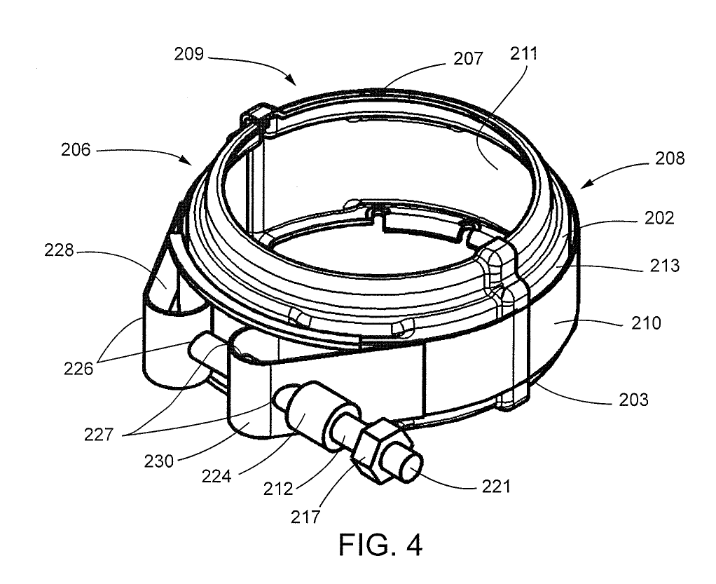

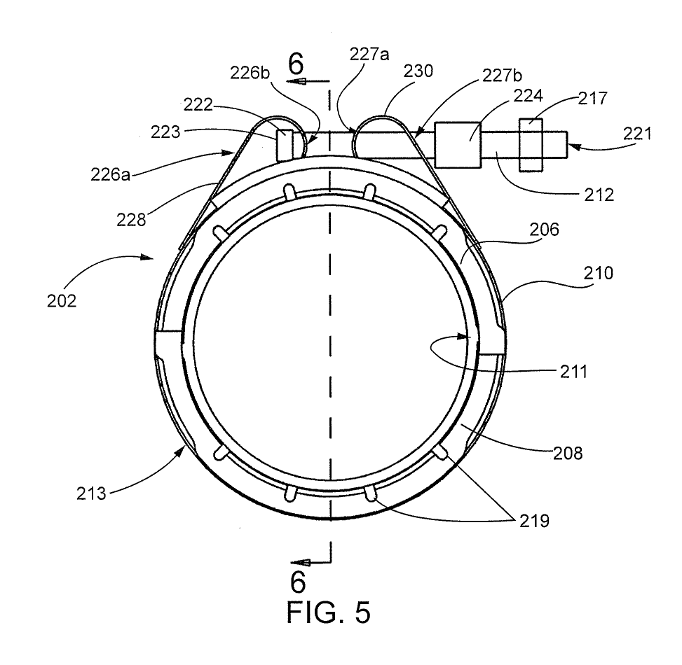

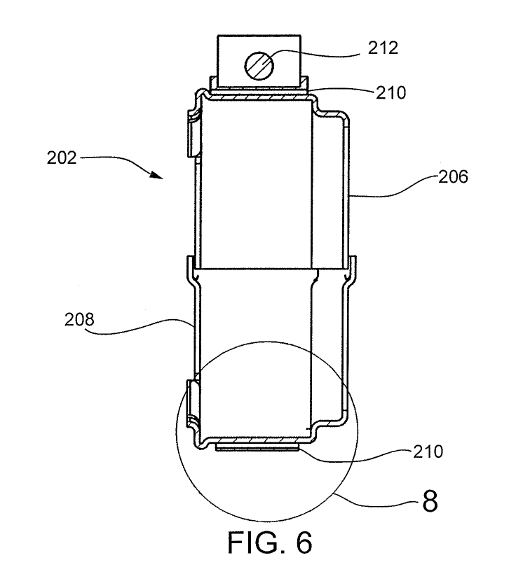

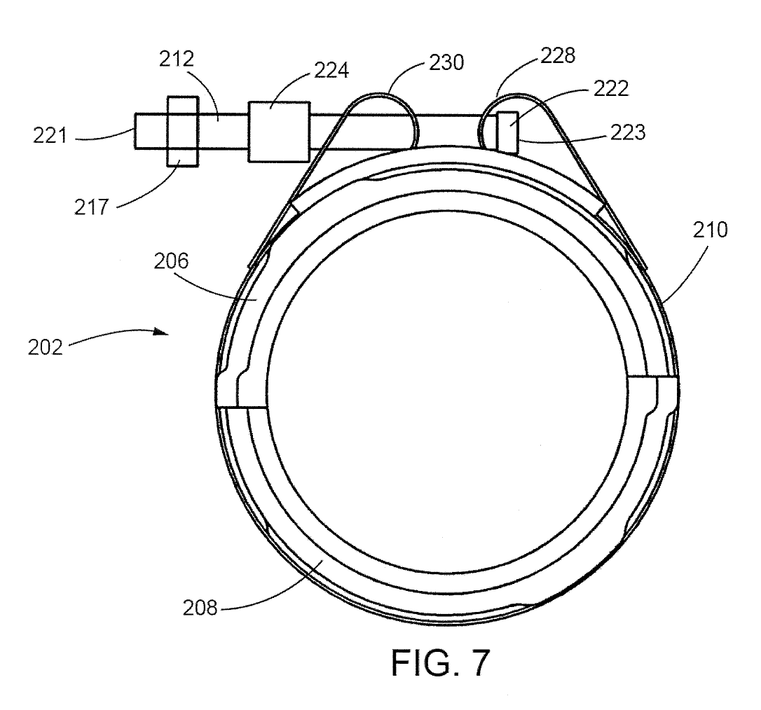

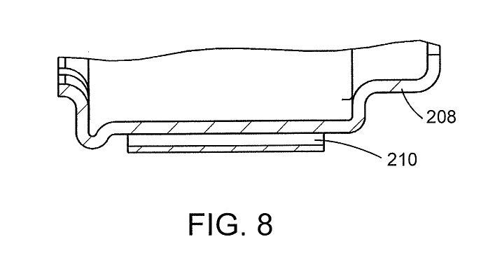

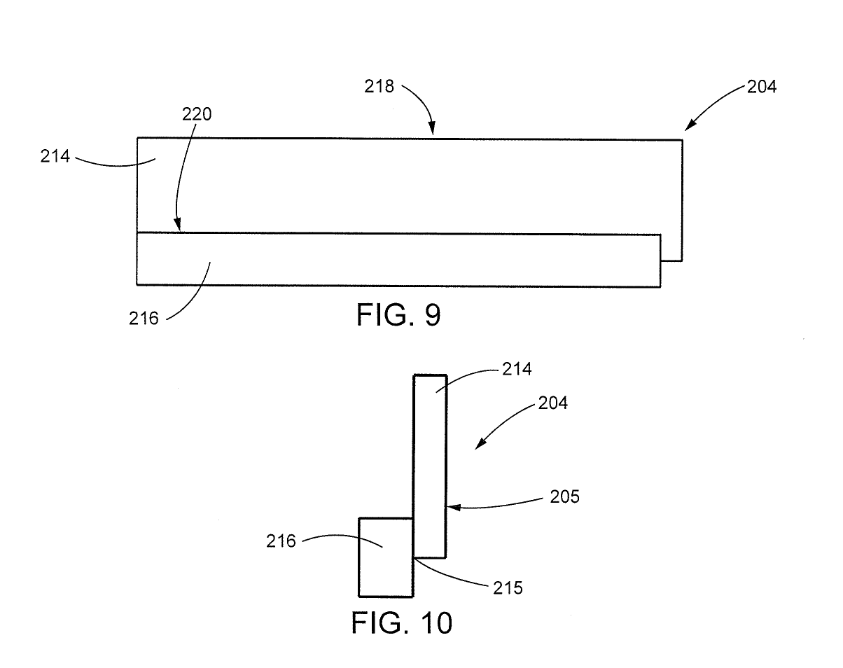

As illustrated in FIG. 3 through FIG. 9, the clamshell clamp 202 has an upper portion 206, a lower portion 208, and a band 210. The upper portion 206 and the lower portion 208 make up the upper and lower halves of a cylinder that nest together to make a substantially cylindrical ring 209 having an inner surface 211 and an outer surface 213. The upper portion 206 and lower portion 208 have notches 219 that aid in shaping of the pieces. The cylindrical ring 209 is made up of a base ring 203 and a protruding ring 207. The band 210 fits around the outer surface 213 of the base ring 203 to hold the nested lower portion 208 and upper portion 206 together. The band 210 has a first loop 228 and a second loop 230, and is secured around the upper portion 206 and lower portion 208 with a T-bolt 212 at the loops. The T-bolt 212 has a proximate end 221 and a distal end 223. The T-bolt 212 has an anchor 222 on the distal end 223 with a diameter larger than the diameter of the T-bolt, and threads near the proximate end 221 that engage threads on a removable nut 217. The T-bolt 212 also has a bushing 224 between the proximate end 221 and distal end 223 with a diameter larger than the diameter of the T-bolt. Although the T-bolt 212, anchor 222, and bushing 224 in the illustrated embodiments are cylindrical, these features can take many other shapes. The bushing 224 is free to slide longitudinally along the T-bolt 212 between the nut 217 and the anchor 222 when the T-bolt is not attached to the band 210.

The band has multiple slots 226a, 226b, 227a, 227b formed in the first loop 228 and the second loop 230, respectively. To install the T-bolt 212, the bushing 224 and nut 217 are removed and the T-bolt is inserted through the slots 226 of the first loop 228. The anchor 222 has a larger diameter than the diameter of slot 226b, so the anchor prevents the T-bolt from sliding completely through the first loop 228. The proximate end 221 of the T-bolt passes through slots 227a, 227b such that at least some threads are outside of the second loop 230. The bushing 224 then slides onto the T-bolt 212 at the proximate end 221, and the nut 217 is threaded onto the proximate and behind the bushing. The bushing 224 has a larger diameter than the slot 227b, so the bushing does not pass into the second loop 230. As the nut 217 is tightened, it forces the bushing 224 toward the distal end 223 so it abuts the outside of the second loop 230 As the nut 217 moves the bushing 224 along the T-bolt 212 toward the distal end 223, the bushing engages the second loop and the anchor 222 engages the first loop 228, pulling the two loops toward one another. As the first loop 228 and the second loop 230 are pulled toward one another, the band 210 tightens around the upper portion 206 and the lower portion 208 of the clamshell clamp 202.

In one embodiment of the clamshell clamp 202, the base ring 203 has an inner diameter of about 77.3 mm and an outer diameter of about 87.3 mm. In this embodiment, the cylindrical ring 209 has a thickness of about 20.8 mm to about 21.8 mm, and more specifically 21.3 mm. The band 210 has a width of between about 18.5 mm to about 19.5 mm, more specifically about 19 mm. Additionally, in this embodiment, the clamshell clamp 202 has an effective range of between about 83 mm in diameter to about 105 mm in diameter. In another embodiment of the clamshell clamp 202, the base ring 203 has an inner diameter of about 78.5 mm and an outer diameter of about 83.9 mm. The clamshell clamp 202 in this embodiment has a thickness of about 32.3 mm to about 33.5 mm, and more specifically about 32.8 mm. The band 210 has a width of between about 15.4 mm to about 16.4 mm, more specifically about 15.9 mm. Additionally, in this embodiment, the clamshell clamp 202 has an effective range of about 74.7 mm in diameter to about 82.6 mm in diameter.

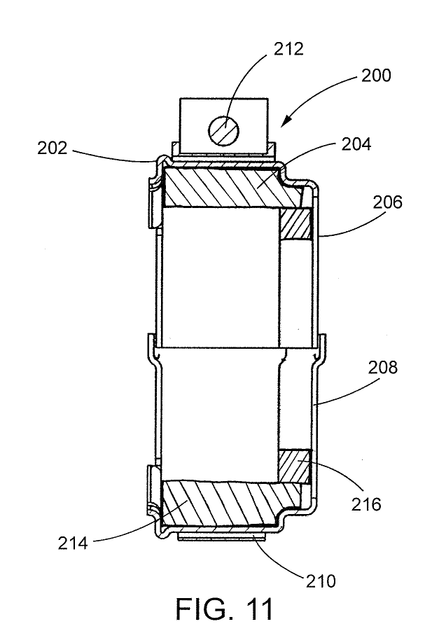

FIG. 10 and FIG. 11 illustrate an embodiment of the filament 204. The filament 204 is made from a porous diesel particulate filter (DPF) or catalyst matting made of, for example, 3M™ Interam® Mat Mount 550 having a density between about 0.68 to about 1.10 g/cm³, and a target density of about 0.85 g/cm³. The filament 204 can be composed of various materials, but in one embodiment, the filament has a weight percentage range of about 30% to about 45% vermiculite, about 45% to about 60% ceramic fiber, and about 6 to about 13% loss on ignition (LOI). The filament 204 has a first portion 214 and a second portion 216, each having an erosion protection surface 218, 220, for example, 3M™ Interam® Erosion Protection Plus (EPP). EPP acts as a fiber bonding agent that significantly reduces erosion caused by forces such as exhaust gas impingement to which the filament 204 may be exposed. The first portion 214 and the second portion 216 can either be two separate pieces adhered to one another or, alternatively, a single piece shaped into two portions. Although the first portion 214 of the filament 204 can have various dimensions, one embodiment of the first portion has a thickness of between about 4.4 mm to about 5.6 mm, more specifically about 5 mm. The first portion 214 can also have a length of about 28 mm and a width of about 245 mm. The first portion 214 can also have a matting with a weight per area between about 2346 g/m² and about 2754 g/m², and more specifically 2250 g/m². The second portion 216 can also have various dimensions, one embodiment having a thickness between about 7.33 mm to about 9.33 mm, more specifically about 8.33 mm. The second portion 216 also has a length of about 12 mm, a width of about 240 mm, and a matting with a weight per area between about 3300 g/m² and about 4590 g/m², and more specifically 4250 g/m². The first portion 214 and the second portion 216 are joined at an interface 215 with glue or any other type of suitable adhesive. The overall thickness of the filament 204 is about 13.3 mm. Alternatively, the first portion 214 and second portion 216 are made from a single piece of matting material. As shown in FIG. 11, in some embodiments of the filament 204, the first portion 214 of the filament has a laminate surface 205 covered in a film laminate.

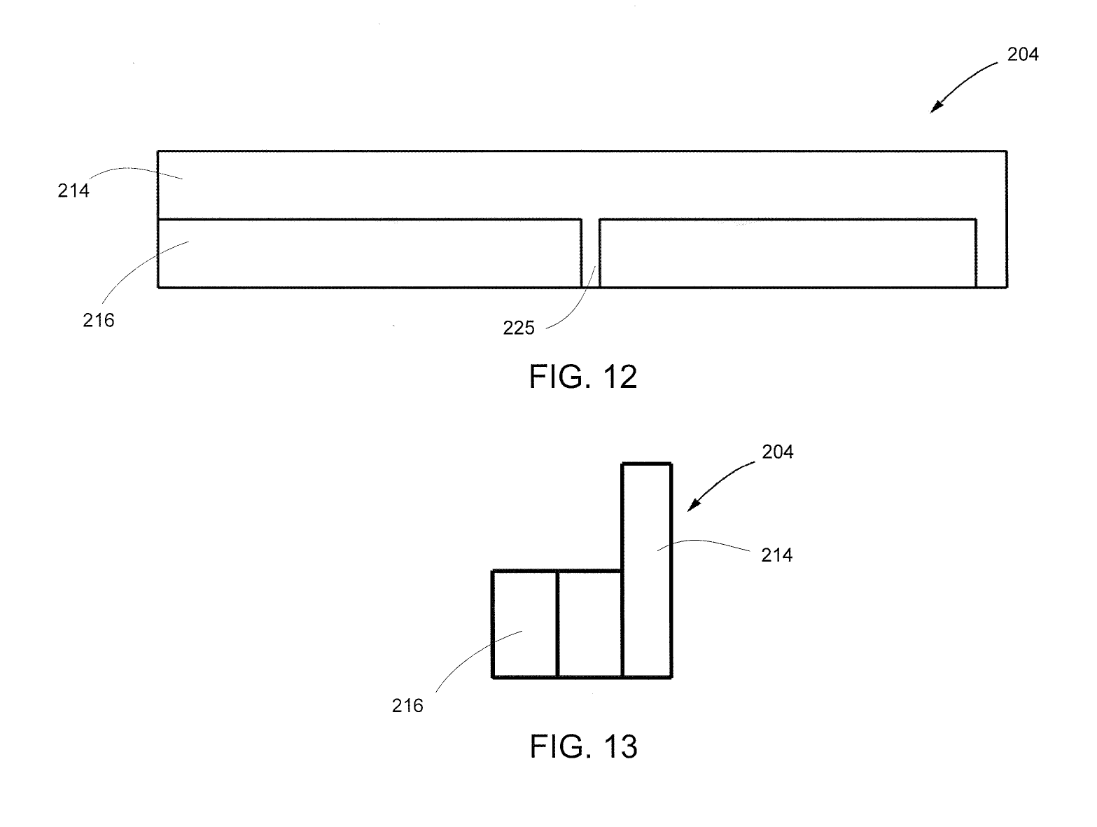

FIG. 12 and FIG. 13 illustrate another embodiment of the filament 204. This embodiment also has a first portion 214 and a second portion 216, but the second portion can be made of two parts with a gap 225. As illustrated in FIG. 12, the second portion can be made from two pieces stacked on top of one another, but can also be made from one piece. Other configurations of the filament are also possible. In this embodiment, the first portion 214 has a length of about 22 mm, a width of about 258 mm, and thickness of about 5 mm. The first portion 214 can also have a matting with a weight per area between about 2346 g/m² and about 2754 g/m², and more specifically 2250 g/m². The second portion 216 is made up of four pieces each having a length of about 11 mm, a width of about 125 mm, and a thickness of about 6.67 mm. The overall thickness of the filament 204 in this embodiment is about 18.3 mm, and the gap 225 is about 3 mm. The second portion 216 also has a matting with a weight per area between about 3300 g/m² and about 4590 g/m², and more specifically 3400 g/m².

As shown in FIG. 2, FIG. 3, and FIG. 11 the filament 204 fits within cylindrical ring formed by the upper portion 206 and lower portion 208 of the clamshell clamp 202. The laminate surface 205 The clamshell clamp 202 holds the filament 204 against the slip joint 100, which seals the joint to prevent leakage from the interface 113 between the outer pipe 102 and inner pipe 104. The filament 204 is positioned within the cylindrical ring 209 such that most of the laminate surface 205 of the first portion 214 contacts the inner surface 211 of the base ring 203. The second portion 216 is positioned almost entirely within the protruding ring 207, such that the second portion substantially fills the annular channel 114. The filament 204 is flexible, so that as the width of the annular channel 114 varies as a result of movement between the inner pipe 104 and the outer pipe 102, the second portion 216 expands or contracts to fill the annular channel. As particulate matter, such as soot, and oil from engine exhaust builds up in the porous matting that makes up the filament 204, the sealing properties of the filament improve as a result of the filament's pores filling with exhaust particles and preventing other particles from leaking out of the slip joint seal 200. The filament 204 material, specifically 3M™ Interam® Mat Mount 550, has properties such that it does not wear from use as quickly as other materials used in prior slip joint seals, such as graphite based seals. By preventing particulate matter from leaking from the slip joint 100, the slip joint seal 200 protects internal and external machine components from oil and soot buildup.

One way to install an embodiment of the slip joint seal 200 on a slip joint 100 is to insert the filament 204 into the lower portion 208 of the clamshell clamp 202 with the laminate surface 205 facing outward toward the lower portion. The filament 204 is then placed around a portion of the slip joint 100 such that the second portion 216 of the filament fits into the gap 111 between the accepting surface 108 and the stop surface 112. The filament 204 is then wrapped around the remainder of the slip joint 100 and the upper portion 206 of the clamshell clamp 202 is placed over the exposed filament such that the upper portion nests with the lower portion 208. Once the upper portion 206 and lower portion 208 are nested with one another, the band 210 is placed around both the upper portion and lower portion. To tighten the band 210 around the upper portion 206 and lower portion 208, the lock pin 212 and the bushing 224 are rotated with respect to one another to draw the first loop 228 and the second loop 230 towards each other. As a result, the filament 204 is pressed securely around the slip joint 100.

While the arrangement is illustrated in connection with exhaust systems in on-highway trucks, the arrangement disclosed herein has universal applicability in various other types of machines as well. The term “machine” may refer to any machine that performs some type of operation associated with an industry such as mining, construction, farming, transportation, or any other industry known in the art. For example, the machine may be an earth-moving machine, such as a wheel loader, excavator, dump truck, backhoe, motor grader, material handler or the like. Moreover, an implement may be connected to the machine. Such implements may be utilized for a variety of tasks, including, for example, loading, compacting, lifting, brushing, and include, for example, buckets, compactors, forked lifting devices, brushes, grapples, cutters, shears, blades, breakers/hammers, augers, and others.

### INDUSTRIAL APPLICABILITY

The industrial application of the apparatus and methods for a slip joint seal in a machine as described herein should be readily appreciated from the foregoing discussion. The present disclosure is applicable to any type of machine utilizing a slip joint. A slip joint generally includes an outer pipe with an accepting end and an inner pipe that includes a flange protruding radially away from an outer diameter of the inner pipe. The outer diameter has a clearance fit when disposed within the inner bore of the accepting end, which defines a slidable interface between the inner pipe and the outer pipe. An annular channel extends peripherally around a portion of the inner pipe defined between a free end of the outer pipe, an outer surface of the inner pipe, and an annular surface of the flange. The annular channel is peripherally open on the side that is radially away from the inner pipe, and is in fluid communication with the slidable interface. The slip joint seal is particularly useful in applications where leakage of particles from a slip joint is undesirable.

The disclosure, therefore, is applicable to many different machines and environments. One exemplary machine suited to the disclosure is an on-highway truck. These trucks are commonly used in many industrial and non-industrial environments and often utilize an exhaust system that include at least one slip joint. In these trucks, the disclosed slip joint seal and methods of using the slip joint are useful in preventing soot and oil from leaking out of the exhaust system slip joints and contaminating the surrounding machinery or environment.

Further, the apparatus and methods described above can be adapted to a large variety of machines. For example, other types of industrial machines using slip joints, such as off-highway trucks, backhoe loaders, compactors, feller bunchers, forest machines, industrial loaders, wheel loaders, tractors and many other machines can benefit from the systems described.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A slip joint seal comprising:
a clamshell clamp comprising:
a generally cylindrical upper portion;
a generally cylindrical lower portion that is mateable with the generally cylindrical upper portion to form a hollow cylindrical ring including a base portion, a protruding portion, an inner surface, and an outer surface; and
a band that fits around the base portion for securing the generally cylindrical upper and lower portions to one another around the slip joint; and
a ceramic fiber filament adapted to discourage leaking from an annular channel formed between an inner pipe and an outer pipe while allowing relative movement between the inner pipe and the outer pipe, the ceramic fiber filament including a first portion that fits substantially within the base portion and is adapted to be disposed in surrounding relation to a portion of the outer pipe around a slidable interface between the inner pipe and the outer pipe, and a second portion that fits substantially within the protruding portion and is adapted to be disposed within and substantially fill the annular channel;
wherein the ceramic fiber filament further comprises vermiculite.

2. The slip joint seal of claim 1 further comprising a T-bolt adapted to secure the band around the upper portion and the lower portion.

3. (canceled)

4. The slip joint seal of claim 1, wherein the ceramic fiber filament comprises:
about 30% to about 45% vermiculite by weight; and
about 45% to about 60% ceramic fiber by weight.

5. The slip joint of claim 1, wherein the ceramic fiber filament has a density of about 0.68 g/cm³ to about 1.10 g/cm³.

6. The slip joint seal of claim 1, wherein the first portion has a length of about 28 mm and the second portion has a length of about 12 mm.

7. The slip joint seal of claim 1, wherein the first portion has a thickness between about 4.4 mm and about 5.6 mm and the second portion has a thickness of about 7.33 mm and about 9.33 mm.

8. An exhaust system comprising:
a slip joint comprising:
an outer pipe including an accepting end, the accepting end including an inner bore;
an inner pipe including a flange protruding radially away from an outer diameter of the inner pipe, the outer diameter including a clearance fit when disposed within the inner bore of the accepting end of the outer pipe;
a slidable interface defined between the inner pipe and the outer pipe; and
an annular channel that extends peripherally around a portion of the inner pipe defined between a free end of the outer pipe, an outer surface of the inner pipe, and an annular surface of the flange, the annular channel being peripherally open on one side thereof that is radially away from the inner pipe and further being in fluid communication with the slidable interface;
a slip joint seal, the slip joint seal comprising:
a clamshell clamp, the clamshell clamp comprising:
a generally cylindrical upper portion;
a generally cylindrical lower portion that is mateable with the generally cylindrical upper portion to form a hollow cylindrical ring including a base portion, a protruding portion, an inner surface, and an outer surface; and
a band that fits around the base portion for securing the upper and lower portions to one another around the slip joint; and
a ceramic fiber filament that discourages leaking from the annular channel while allowing relative movement between the inner pipe and the outer pipe, the ceramic fiber filament including a first portion that fits substantially within the base portion and is adapted to be disposed in surrounding relation to a portion of the outer pipe around the slidable interface, and a second portion that fits substantially within the protruding portion and is adapted to be disposed within and substantially fill the annular channel.

9. The exhaust system of claim 8 further comprising a T-bolt adapted to secure the band around the upper portion and the lower portion.

10. The exhaust system of claim 8 wherein the ceramic fiber filament further comprises vermiculite.

11. The exhaust system of claim 10, wherein the ceramic fiber filament is composed of:
about 30% to about 45% vermiculite by weight; and
about 45% to about 60% ceramic fiber by weight.

12. The exhaust system of claim 8, wherein the ceramic fiber filament has a density of about 0.68 g/cm³ to about 1.10 g/cm³.

13. The exhaust system of claim 8, wherein the first portion has a length of about 28 mm and the second portion has a length of about 12 mm.

14. The exhaust system of claim 8, wherein the first portion has a thickness between about 4.4 mm and about 5.6 mm and the second portion has a thickness of about 7.33 mm and about 9.33 mm.

15. A method for sealing a slip joint, comprising:
sliding an inner pipe including an outer diameter and a flange protruding radially away from the outer diameter at least partially into an inner bore of an accepting end of an outer pipe to form the slip joint between the inner and outer pipes, the outer diameter and inner bore being sized to provide a clearance fit therebetween, such that an annular channel that extends peripherally around a portion of the inner pipe is defined between a free end of the outer pipe, an outer surface of the inner pipe, and an annular surface of the flange, the annular channel being peripherally open on one side thereof that is radially away from the inner pipe and further being in fluid communication with a slidable interface;
assembling upper and lower portions of a clamshell clamp to one another to form a hollow cylindrical ring around the slip joint, the hollow cylindrical ring including a base portion, a protruding portion, an inner surface, and an outer surface;
fitting a band around the base portion and securing the upper and lower portions to one another around the slip joint;
installing a ceramic fiber filament around the slip joint that discourages leaking from the annular channel while allowing relative movement between the inner pipe and the outer pipe, the ceramic fiber filament including a first portion and a second portion such that:
the first portion is substantially within the base portion in surrounding relation to a portion of the outer pipe around the slidable interface; and
the second portion is substantially disposed within the protruding portion and extends into and substantially fills the annular channel.

16. The method of claim 15 further comprising installing a T-bolt to secure the band around the upper portion and the lower portion.

17. The method of claim 15, wherein the ceramic fiber filament further comprises vermiculite.

18. The method of claim 17, wherein the ceramic fiber filament is composed of:
about 30% to about 45% vermiculite by weight; and
about 45% to about 60% ceramic fiber by weight.

19. The method of claim 15, wherein the ceramic fiber filament has a density of about 0.68 g/cm³ to about 1.10 g/cm³.

20. The method of claim 15, wherein the first portion has a length of about 28 mm and the second portion has a length of about 12 mm.
